(19) United States
(12) Patent Application Publication
(10) Pub. No.: US 2025/0006188 A1
(43) Pub. Date: Jan. 2, 2025

(54) CONTEXT-BASED ANTI-SPAM APPLICATION ENABLED WITH HUMAN-COMPUTER INTERACTION ANALYSIS

(71) Applicant: INTERNATIONAL BUSINESS MACHINES CORPORATION, Armonk, NY (US)

(72) Inventors: YANG LIANG, BeiJing (CN); Jun Su, Beijing (CN); Demetrice L Browder, Liberty Hill, TX (US); Su Liu, Austin, TX (US)

(21) Appl. No.: 18/343,323

(22) Filed: Jun. 28, 2023

(51) Int. Cl. G10L 15/22; G06F 40/58; G10L 13/033; G10L 15/06; G10L 15/18; H04M 3/436

(52) U.S. Cl. CPC G10L 15/22; G06F 40/58; G10L 13/033; G10L 15/063; G10L 15/1815; H04M 3/436; G10L 2015/088; G10L 15/30

(57) ABSTRACT

An anti-spambot application that incorporates mechanisms for human-computer interaction is configured. In response to determining that a telephonic call from a caller to a callee is a spam call, the process switches to a mode in which the anti-spambot application initiates a conversation with the caller. A script is selected from a predetermined set of scripts based on content included in the telephonic call. Synthesized speech is generated from the script, based on voice characteristics of the callee, where the synthesized speech is used for conversing with the caller.

### BACKGROUND

Embodiments relate to a method, system, and computer program product for a context-based anti-spam application enabled with human-computer interaction analysis.

Spam is any kind of unwanted, unsolicited digital communication. Spam is often sent via email, but spam may also be distributed via text messages, phone calls, or social media. Spam calls are a major problem and may not only cause inconvenience to recipients, but may also be used to perpetrate fraud on recipients. There are many existing mechanisms to detect, block, and prevent spam calls, including mechanisms that use crowd-sourcing based lists to block and manage spam calls.

A spambot is a computer program designed to assist in the sending of spam. Anti-spambot applications may be used to detect, block, and prevent spam received from spambots.

Human-computer interaction (HCI) is a discipline that focuses on determining how users and computers interact. HCI programs may provide interactive computer interfaces that satisfy the needs of a user to interact with a computer. HCI is a multidisciplinary subject covering computer science and behavioral sciences.

### SUMMARY

Provided are a method, system, and computer program product in which an anti-spambot application that incorporates mechanisms for human-computer interaction is configured. In response to determining that a telephonic call from a caller to a callee is a spam call, the process switches to a mode in which the anti-spambot application initiates a conversation with the caller. A script is selected from a predetermined set of scripts based on content included in the telephonic call. Synthesized speech is generated from the script, based on voice characteristics of the callee, where the synthesized speech is used for conversing with the caller.

In additional embodiments, the anti-spambot application monitors conversations in phone calls and social media, based on permission settings in a profile of the callee. A sampling is performed of vocal characteristics to detect spamming information and topics in real time.

In further embodiments, the synthesized speech is in a language and locale of the callee. A conversation is evaluated based on an evaluation criteria including conversation length and reaction of the caller. Operations are performed for adjusting and improving the predetermined set of scripts for future interaction with callers.

In certain embodiments operations are performed for learning human-computer interaction in previously stored conversations between callers and callees. Topics, key words, purposes, roles of caller and callee are categorized into different human-computer interaction patterns for conducting automated conversation.

In certain additional embodiments, operations are performed for generating a corpus of anti-spam question-answer scripts for a plurality of topics according to human-computer interaction patterns during spam calls. The corpus of anti-spam question-answer scripts are translated to a plurality of serviced languages. Operations are performed for saving and updating the corpus of anti-spam question answer scripts.

In certain embodiments, a framework is defined to support the anti-spambot application. A graphical user interface is provided for managing the anti-spambot application.

In further embodiments, a data structure is defined for storing, tracking, and analyzing conversation topics and contexts.

### BRIEF DESCRIPTION OF THE DRAWINGS

Referring now to the drawings in which like reference numbers represent corresponding parts throughout:

FIG. 1 illustrates a block diagram of a computing environment for an anti-spambot application, in accordance with certain embodiments.

FIG. 2 illustrates a block diagram that shows the phases of an anti-spambot application, in accordance with certain embodiments.

FIG. 3 illustrates a block diagram that shows the components of an anti-spambot application, in accordance with certain embodiments.

FIG. 4 illustrates a flowchart that includes operations performed by an anti-spambot application, in accordance with certain embodiments.

FIG. 5 illustrates a block diagram that shows the configuration phase of an anti-spambot application, in accordance with certain embodiments.

FIG. 6 illustrates a block diagram that shows the training/learning phase of an anti-spambot application, in accordance with certain embodiments.

FIG. 7 illustrates a block diagram that shows the real-time service phase of an anti-spambot application, in accordance with certain embodiments.

FIG. 8 illustrates a block diagram that shows an example of a human-computer interaction analysis, in accordance with certain embodiments.

FIG. 9 illustrates a block diagram that shows a dynamic CASB data structure state, in accordance with certain embodiments.

FIG. 10 illustrates a block diagram that shows operations of an anti-spambot application, in accordance with certain embodiments.

FIG. 11 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Current anti-spam mechanisms may not be efficient because many spamming call patterns have been iteratively upgraded and customized according to the personal characteristics of the recipient of the spam. For instance, it is hard to use a blocking list method to prevent certain types of frauds, because the spammers may use the personal characteristics and vulnerabilities collected from a recipient's social media posts and conversations to customize and redesign the conversational patterns used in spam calls.

Certain embodiments address the following issues:
(1) How to use Human-Computer Interaction (HCI) technology to anti-spam calls?
(2) How to detect potential victims in certain customized spam calls and Internet scams?
(3) How to select and build a set of useful Human-Computer Interactions (HCIs) to proactively reduce or suppress risks of spam calls?
(4) How to protect potential victims from customized spam calls and internet scams?
(5) How to define a Human-Computer Interaction based Anti-spambot?
(6) How to preemptively prevent customized spam calls and internet frauds based on human-computer interaction patterns?

As a result of certain embodiments that mitigate the impact of spam calls, performance improvements are made in the operations of computing and telephony systems.

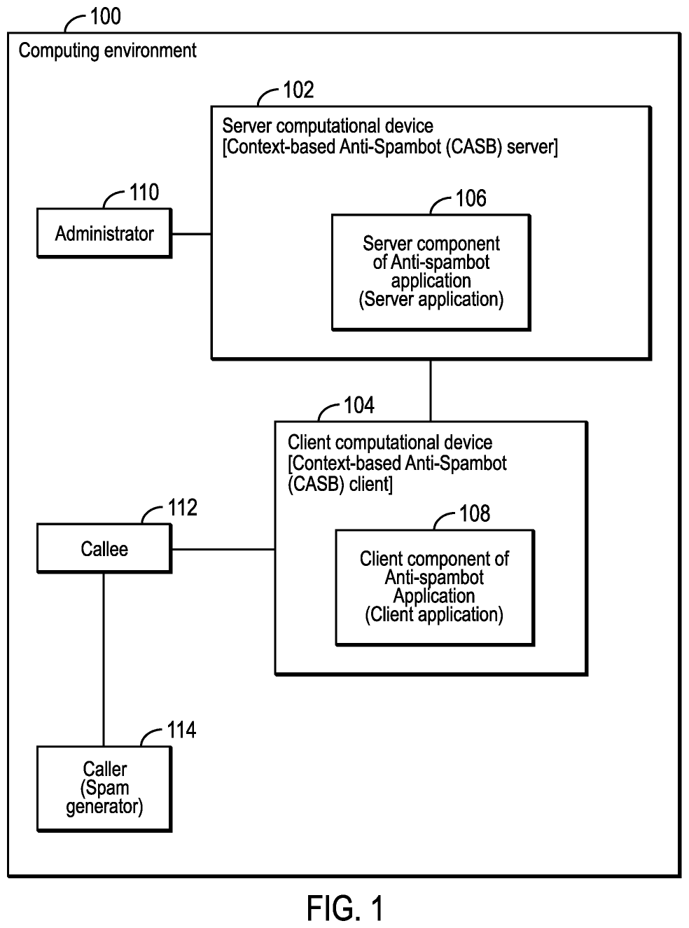

FIG. 1 illustrates a block diagram of a computing environment 100 for an anti-spambot application, in accordance with certain embodiments.

A server computational device [referred to as a Context-based Anti-Spambot (CASB) server 102] is coupled to a client computational device [referred to as a CASB client 104].

The CASB server 102 executes a server component 106 of an anti-spambot application, whereas the CASB client 104 executes a client component 108 of the anti-spambot application. The server component 106 of the anti-spambot application may also be referred to as a server application 106, and the client component 108 of the anti-spambot application may also be referred to as a client application 106.

An administrator 110 may configure the server application 106 and optionally the client application 108, such that when a callee 112 receives spam calls from a caller 114, the client application 108 in coordination with the server application 106 protects the callee 112 from the spam calls of the caller 114.

In certain embodiments, the server computational device 102 and the client computational device 104 in FIG. 1 may comprise any suitable computational device including those presently known in the art, such as, a personal computer, a workstation, a mainframe, a hand held computer, a palm top computer, a head mounted computer, a telephony device, a network appliance, a blade computer, a processing device, a controller, etc. The elements shown in FIG. 1 may be in any suitable network, such as a storage area network, a wide area network, the Internet, an intranet, etc., or in a cloud computing environment.

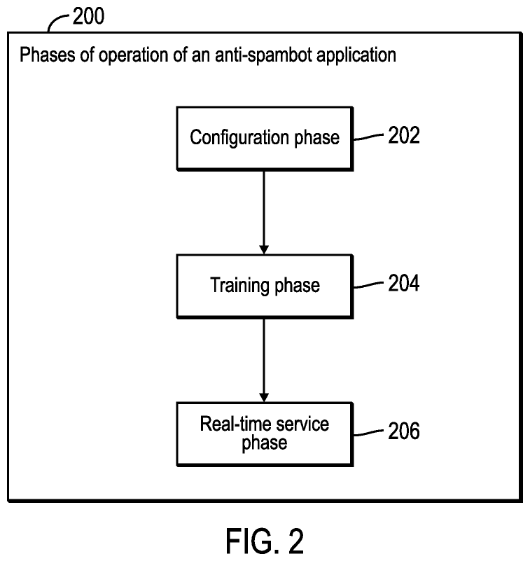

FIG. 2 illustrates a block diagram 200 that shows the phases of operation of an anti-spambot application, in accordance with certain embodiments.

Initially, in a configuration phase 202, the administrator 110 configures the server application 106 and optionally the client application 108 to define a framework to support an anti-spambot application.

From the configuration phase 202, control proceeds to the training phase 204 in which learning mechanisms may be used for learning Human-Computer Interaction in previously logged spamming conversations.

Control proceeds to the real-time service phase 206 in which the anti-spambot application monitors conversations and if necessary, performs automated conversation with the spam generating caller to protect the callee from spams.

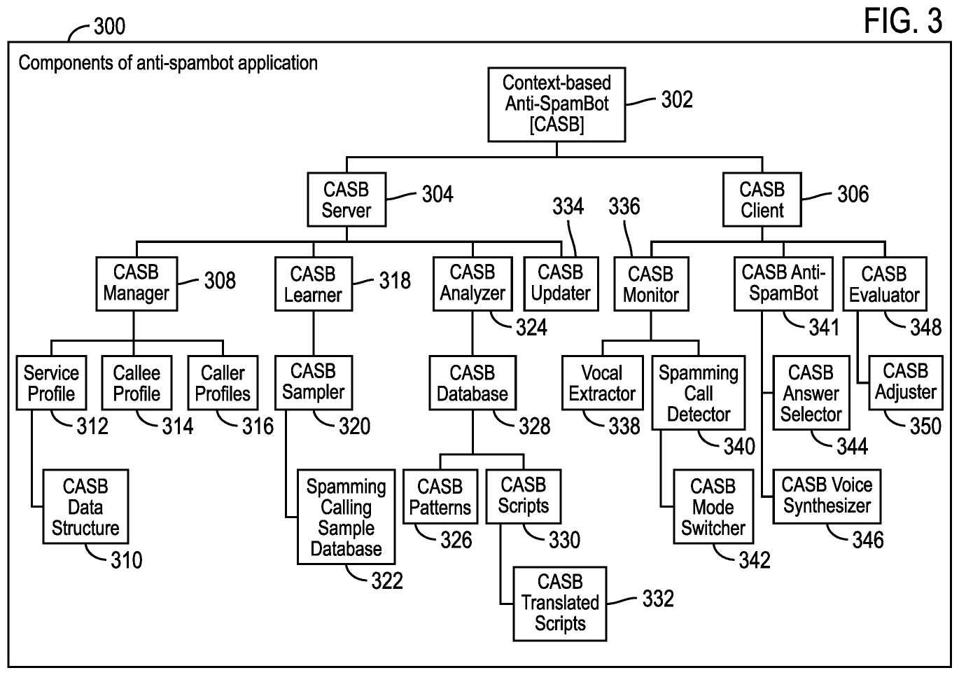

FIG. 3 illustrates a block diagram 300 that shows the components of an anti-spambot application, in accordance with certain embodiments.

Certain embodiments provide a Context-based Anti-SpamBot [CASB] 302 enabled with Human-Computer Interaction Analysis for detecting potential victims in certain customized spam calls and internet scams, thereby protecting potential victims from certain customized spam calls and internet scams, and preventing customized spam calls and internet frauds based on human-computer interaction patterns.

In certain embodiments, a framework is defined to support the Context-based Anti-SpamBot [CASB] 302 where the framework is built on the CASB Server 304 (also referred to by reference numeral 102 in FIG. 1) and the CASB Client 306 (also referred to by reference numeral 104 in FIG. 1).

The embodiments provide a graphical user interface (GUI) to a user for managing the CASB [CASB Manager 308]. A CASB Data Structure 310 is defined for storing, tracking, and analyzing conversation topics and context. An example of CASB Data Structure is as follows: [CalleeID, Callee VoiceID, CallerID, CallerVoice ID, ConversationBuffer, HCIpattern (VulnerabilityGroup, SpammingType), SpammingTopicList, AnswerScript [SpammingTopicList], SynthesizedAnswer, Callee-Locale].

Service profile 312, callee profile 314, and caller profile 316 may be associated with the CASB data structure 310.

In the training phase, a CASB Learner 318 learns Human-Computer Interaction in logged spamming conversation that includes questions, roles, and answers. A CASB Sampler 320 and Spamming Calling Sample Database 322 may be used for sampling spamming topics and answers.

Operations are performed to analyze the sampled spamming material of Human-Computer Interaction via a CASB Analyzer 324. Operations are performed for categorizing Vulnerability Groups, Spamming Types (such as topics, key words, purposes, caller's roles, caller's voice, caller's phone-number, etc.) into different Spamming Human-Computer Interaction Patterns [CASB Patterns 326] by using a CASB database 328.

Certain embodiments generate a corpus of Anti-Spam Question-Answer Scripts for each topic according to Spamming Human-Computer Interaction Patterns [CASB Scripts 330]. Facilities are provided for translating the generated Anti-Spam Question-Answer Scripts to multiple serviced languages [CASB Translated Scripts 332].

Operations are performed for saving and updating all Anti-Spam Question-Answer Scripts [CASB Updater 334, CASB Database 328].

During the real time service phase, the following operations are performed:
(a) monitoring conversations in phone calls and social medias as needed (based on permission setting in callee's profile) [CASB Monitor 336];
(b) sampling user's vocal characteristics (such as language, locale. volume, pace, pitch, rate, rhythm, fluency, articulation, pronunciation, enunciation, tone, etc.) (Vocal Extractor 338);
(c) detecting spamming information and topics in real time, proactively [Spamming Call Detector 340];
(d) switching to CASB mode and letting Anti-Spambot 341 take over the conversation. [CASB Mode Switcher 342];
(e) selecting a proper script with right CASB Question-Answer Pattern [CASB Answer Selector 344];
(f) synthesizing the selected script to speech based on the registered callee's voice characteristics. [CASB Voice Synthesizer 346];
(g) chatting with caller (spammer) by using the selected script and/or synthesized voice in the determined language/locale [CASB Anti-SpamBot 341];
(h) evaluating the conversation based CASB evaluation criteria (conversation length, spammer reaction, spammer speech mood, etc.) [CASB Evaluator 348]; and
(i) adjusting and improving the Anti-Spam Question-Answer Scripts according to earlier conversations [CASB Adjuster 350].

While FIG. 3 shows numerous components, many of the components could be merged together into one component. Also, many of the components may be split into sub-components.

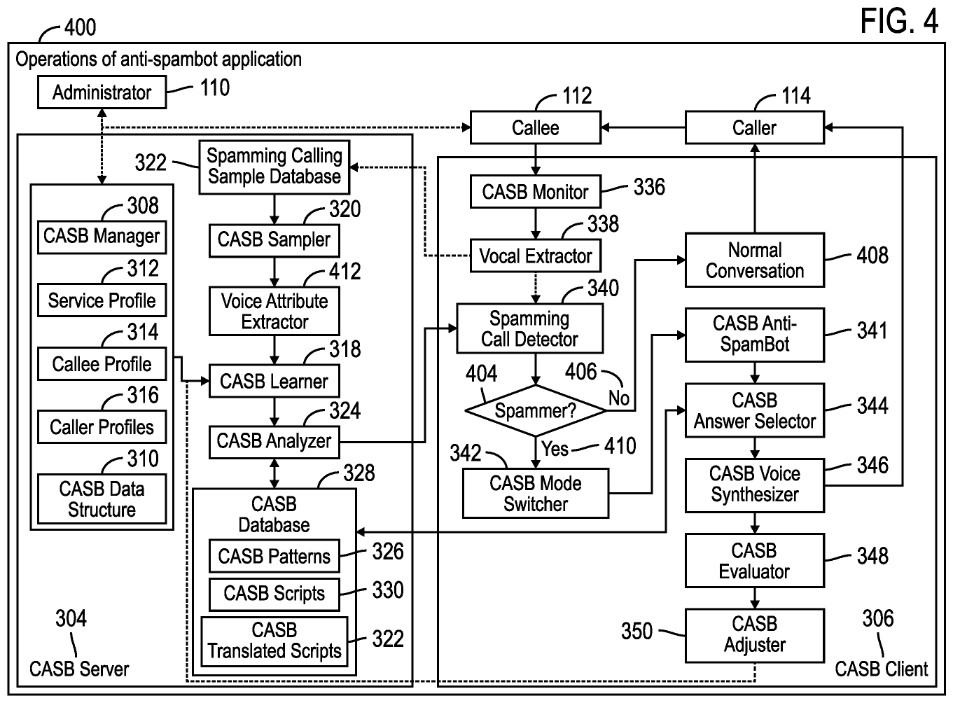

FIG. 4 illustrates a flowchart 400 that includes operations performed by an anti-spambot application, in accordance with certain embodiments.

In FIG. 4, the administrator 110 configurates the CASB manager 308, the service profile 312, the callee profile 314, the caller profiles 310 and the CASB data structure 310. Control then proceeds to the CASB learner 318.

A caller 114 may make a call to the callee 112. In the CASB client 306 the CASB monitor 336 uses the vocal extractor 338 and the spamming call detector 340 and makes a determination at block 404 as to whether the caller 114 is a spammer. If not (branch 406), control proceeds to block 408 and normal conversation between the caller 114 and callee 112 takes place.

If at block 404, a determination is made that the caller 114 is a spammer (branch 410) then the CASB mode switcher 342 activates the CASB anti-spambot 341. The CASB anti-spambot 341 then conducts a conversation with the caller 114 by impersonating the voice and other characteristics of the callee 112 and iteratively improves on the system based on experience (as shown via reference numerals 344, 346, 348, 350).

The CASB monitor 336 uses the vocal extractor 338 when a call is received by the callee 112 and communicates with CASB server 304 where the spamming calling sampling database 322, the CASB sampler 320, the voice attribute extractor 412, the CASB learner 318, and the CASB database 328 are used to provide appropriate input to the spamming call detector 340 that executes in the CASB client 306 for determining whether the caller 114 is a spammer.

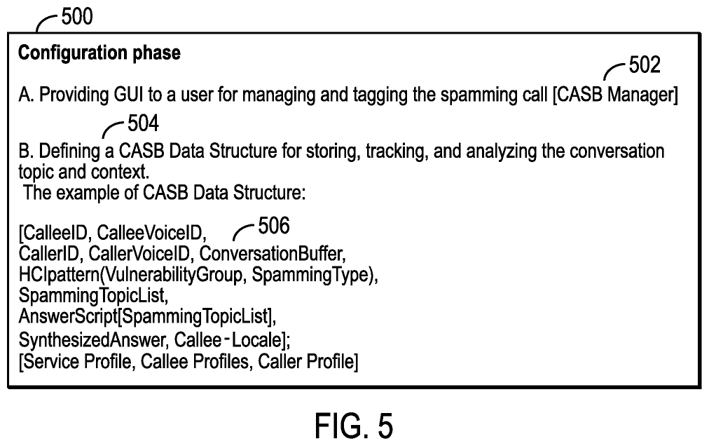

FIG. 5 illustrates a block diagram 500 that shows the configuration phase of an anti-spambot application, in accordance with certain embodiments.

In the configuration phase an administrator provides a GUI to a user for managing and tagging the spamming call via the CASB manager 308 (as shown via reference numeral 502).

The process defines a CASB Data Structure 310 for storing, tracking, and analyzing the conversation topic and context (shown via reference numeral 504). An example of a CASB Data Structure that includes Callee identifier (ID), Callee Voice ID, Caller ID, Caller Voice ID, Conversation Buffer, HCI pattern including Vulnerability Group, Spamming Type, Spamming Topic List, Answer Script, Synthesized Answers, Callee Locales, Service Profiles, Callee Profiles, Caller Profiles are also shown (via reference numeral 506).

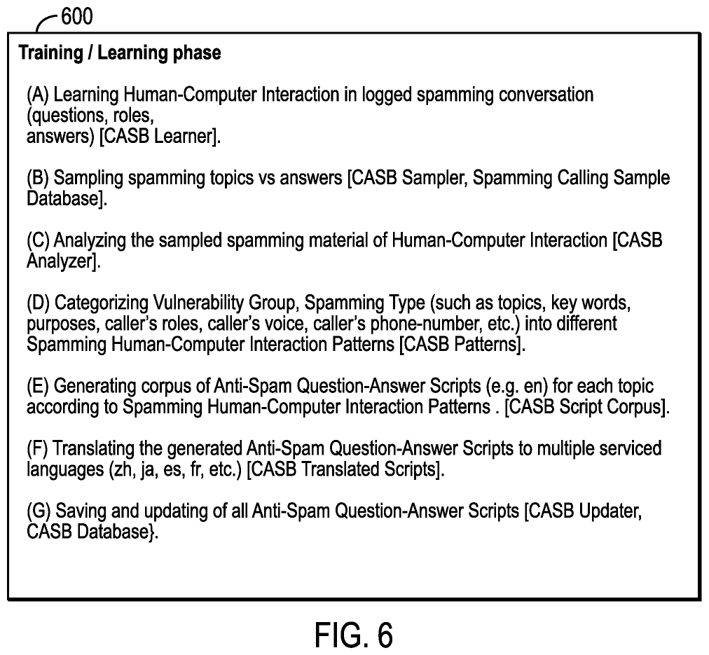

FIG. 6 illustrates a block diagram 600 that shows the training and learning phase of an anti-spambot application, in accordance with certain embodiments.

In the training and learning phase the following operations may be performed with the component performing the operations shown in square brackets after the operations:
(A) Learning Human-Computer Interaction in logged spamming conversation (questions, roles, answers) [CASB Learner 318];
(B) Sampling spamming topics vs answers [CASB Sampler 320, Spamming Calling Sample Database 322];
(C) Analyzing the sampled spamming material of Human-Computer Interaction [CASB Analyzer 324];
(D) Categorizing Vulnerability Group, Spamming Type (such as topics, key words, purposes, caller's roles, caller's voice, caller's phone-number, etc.) into different Spamming Human-Computer Interaction Patterns [CASB Patterns 326];
(E) Generating corpus of Anti-Spam Question-Answer Scripts for each topic according to Spamming Human-Computer Interaction Patterns [CASB Script 330];
(F) Translating the generated Anti-Spam Question-Answer Scripts to multiple serviced languages (e.g., Spanish, French, etc.) [CASB Translated Scripts 332]
(G) Saving and updating of all Anti-Spam Question-Answer Scripts [CASB Updater 334, CASB Database 328].

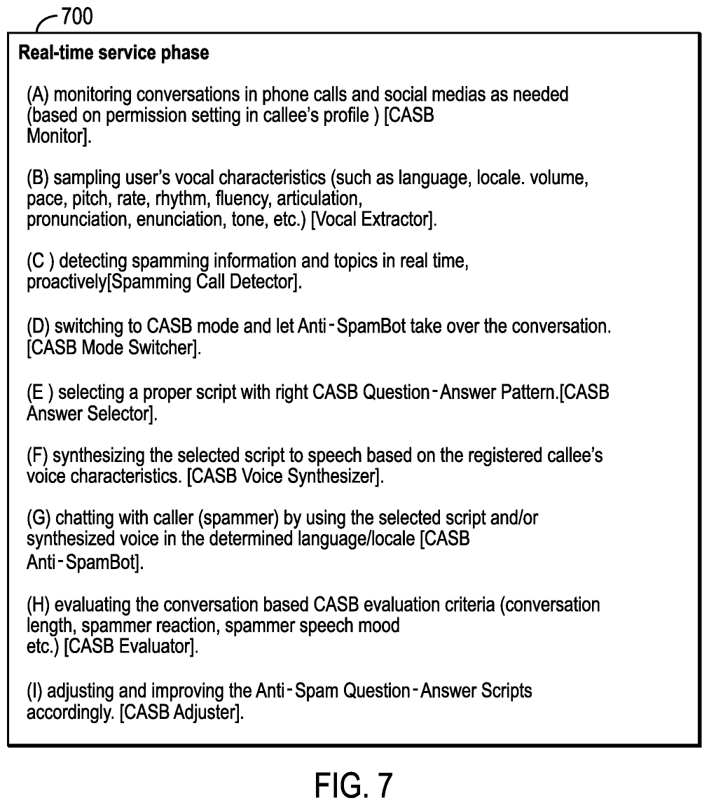

FIG. 7 illustrates a block diagram 700 that shows the real-time service phase of an anti-spambot application, in accordance with certain embodiments.

In the real-time service phase, the following operations may be performed with the component performing the operations shown in square brackets after the operations:
(A) monitoring conversations in phone calls and social medias as needed (based on permission setting in callee's profile) [CASB Monitor 336];
(B) sampling user's vocal characteristics (such as language, locale. volume, pace, pitch, rate, rhythm, fluency, articulation, pronunciation, enunciation, tone, etc.) (Vocal Extractor 338);
(C) detecting spamming information and topics in real time, proactively [Spamming Call Detector 340];
(D) switching to CASB mode and letting Anti-Spambot 341 take over the conversation. [CASB Mode Switcher 342];
(E) selecting a proper script with right CASB Question-Answer Pattern [CASB Answer Selector 344];
(F) synthesizing the selected script to speech based on the registered callee's voice characteristics. [CASB Voice Synthesizer 346];
(G) chatting with caller (spammer) by using the selected script and/or synthesized voice in the determined language/locale [CASB Anti-SpamBot 341];
(H) evaluating the conversation based CASB evaluation criteria (conversation length, spammer reaction, spammer speech mood, etc.) [CASB Evaluator 348]; and
(I) adjusting and improving the Anti-Spam Question-Answer Scripts [CASB Adjuster 350].

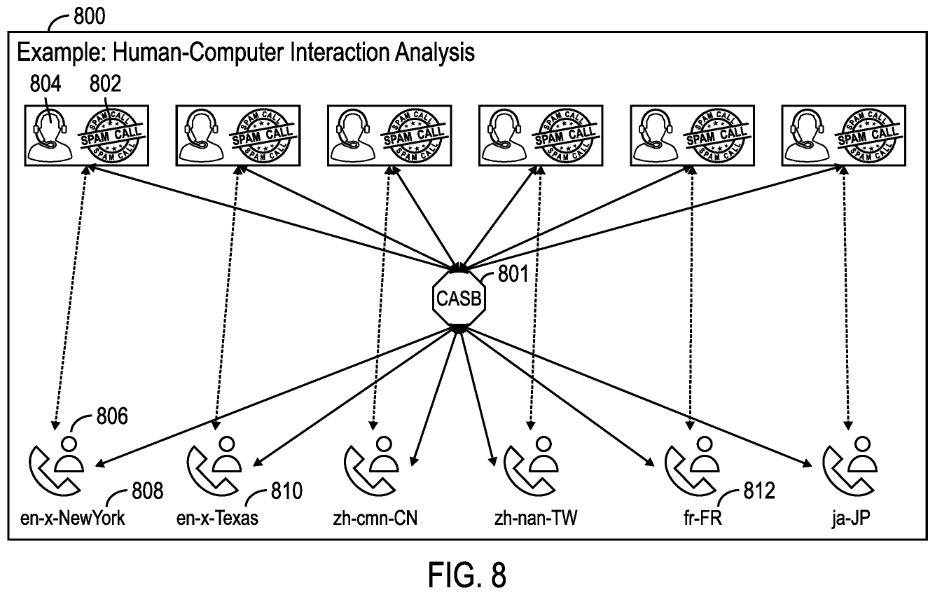

FIG. 8 illustrates a block diagram 800 that shows an example of a human-computer interaction analysis, in accordance with certain embodiments.

The CASB 801 may intercept and manage the spam calls made from callers. For example, the CASB 801 may intercept the spam call 802 made by the caller 804 to the callee 806 who is shown in FIG. 8 to be in New York speaking English in the accent used in New York (shown via reference numeral 808). In such a case the CASB 801 may speak to the spammer in the English accent used by New Yorkers. The CASB 801 may speak in other English accents such as those spoken in Texas (shown via reference numeral 810) or in another language such as French (shown via reference numeral 812).

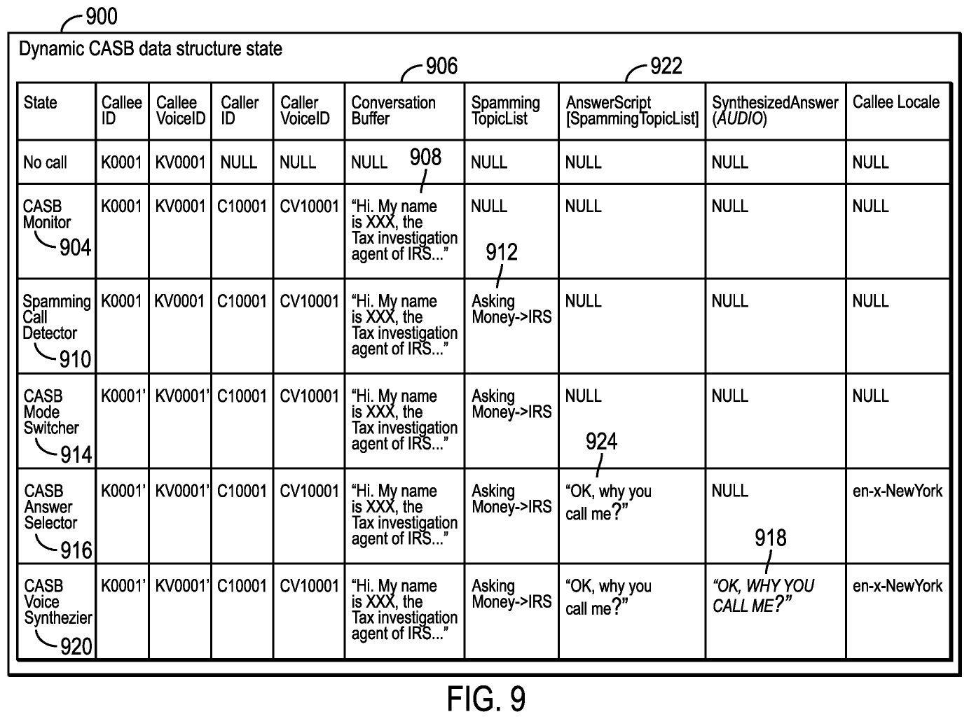

FIG. 9 illustrates a block diagram 900 that shows a dynamic CASB data structure state in accordance with certain embodiments.

In FIG. 9, the CASB monitor 904 may analyze in the conversation buffer 906 a call that includes the word “IRS” which is a short form of Internal Revenue Service, the tax authority of the United States (shown via reference numeral 908). The Spamming call detector 910 may determine that the caller is making a spam call asking for money (shown via reference numeral 912) based on the word “IRS”. The CASB mode detector 914 then switches mode to start a synthesized conversation with the caller and the CASB answer selector 916 asks the caller “OK, why you call me” 918 by using the CASB voice synthesizer 920 based on an answer script 922 that stores the answer 924. Human-computer interaction mechanisms are used to generate such conversation with the spambot.

It may be noted that Text to Speech (TTS) may provide mechanisms for Voice attributes to be extracted, identified, and categorized and the speech of a callee may be synthesized to impersonate the callee to a spammer. The spammer call is detected and tagged by the CASB. Phonology, morphology, syntax, and semantic analysis may be performed by the CASB to engage in conversation with the spambot or caller to protect the callee.

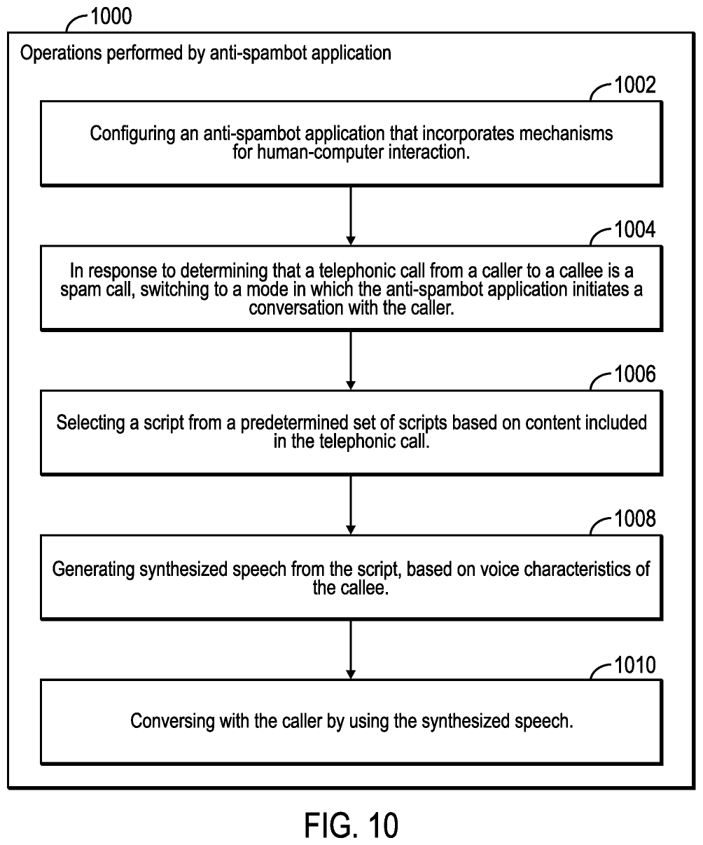

FIG. 10 illustrates a block diagram 1000 that shows operations of an anti-spambot application, in accordance with certain embodiments. The operations shown in FIG. 10 may be performed in the computing environment 100 shown in FIG. 1 in one or more computational devices.

Control starts at block 1002 in which an anti-spambot application that incorporates mechanisms for human-computer interaction is configured. In response to determining that a telephonic call from a caller to a callee is a spam call, the process switches (at block 1004) to a mode in which the anti-spambot application initiates a conversation with the caller.

From block 1004 control proceeds to block 1006 in which a script is selected from a predetermined set of scripts based on content included in the telephonic call. Synthesized speech is generated (at block 1008) from the script, based on voice characteristics of the callee, where the synthesized speech is used (at block 1010) for conversing with the caller.

Therefore, FIGS. 1-10 illustrate embodiments for an anti-spambot application that protects a user from spam calls.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

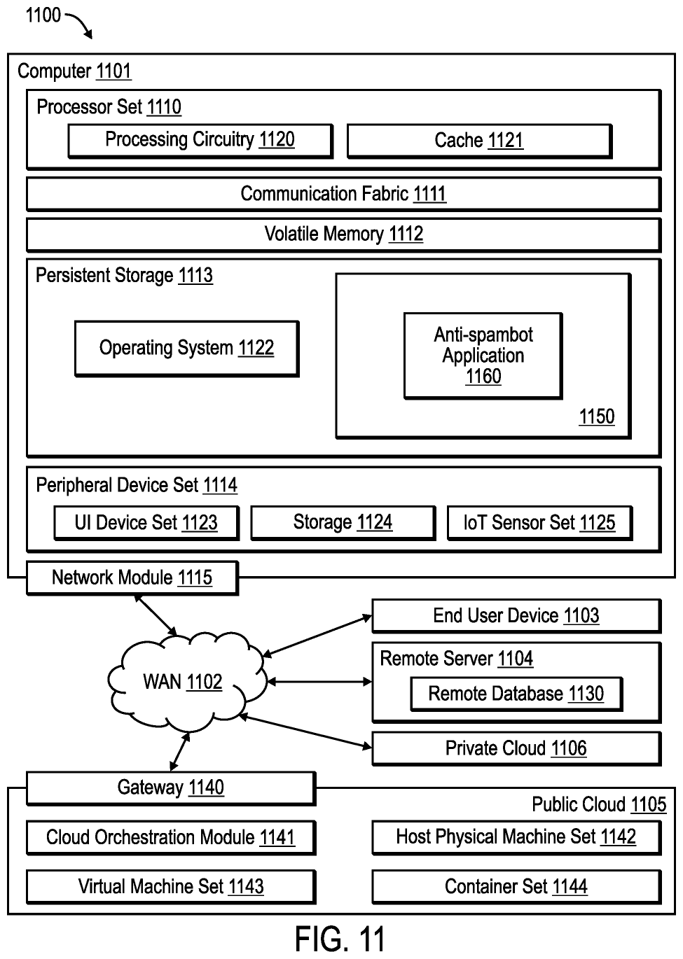

In FIG. 11, computing environment 1100 contains an example of an environment for the execution of at least some of the computer code (block 1150) involved in performing the operations of an anti-spambot application 1160 that performs operations shown in FIGS. 1-10.

In addition to block 1150, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1150, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1150 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface-type operating systems that employ a kernel. The code included in block 1150 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. I/O T sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
configuring an anti-spambot application that incorporates mechanisms for human-computer interaction;
in response to determining that a telephonic call from a caller to a callee is a spam call, switching to a mode in which the anti-spambot application initiates a conversation with the caller;
selecting a script from a predetermined set of scripts based on content included in the telephonic call;
generating synthesized speech from the script, based on voice characteristics of the callee; and
conversing with the caller by using the synthesized speech.

2. The method of claim 1, the method further comprising:
monitoring, by the anti-spambot application, conversations in phone calls and social media, based on permission settings in a profile of the callee; and
sampling vocal characteristics to detect spamming information and topics in real time.

3. The method of claim 1, wherein the synthesized speech is in a language and locale of the callee, the method further comprising:
evaluating a conversation based on an evaluation criteria including conversation length and reaction of the caller; and
adjusting and improving the predetermined set of scripts for future interaction with callers.

4. The method of claim 1, the method further comprising:
learning human-computer interaction in previously stored conversations between callers and callees; and
categorizing topics, key words, purposes, roles of caller and callee into different human-computer interaction patterns for conducting automated conversation.

5. The method of claim 1, the method further comprising:
generating a corpus of anti-spam question-answer scripts for a plurality of topics according to human-computer interaction patterns during spam calls;
translating the corpus of anti-spam question-answer scripts to a plurality of serviced languages; and
saving and updating the corpus of anti-spam question answer scripts.

6. The method of claim 1, the method further comprising:
defining a framework to support the anti-spambot application; and
providing graphical user interface for managing the anti-spambot application.

7. The method of claim 6, the method further comprising:
defining a data structure for storing, tracking, and analyzing conversation topics and contexts.

8. A system, comprising:
a memory; and
a processor coupled to the memory, wherein the processor performs operations, the operations comprising:
configuring an anti-spambot application that incorporates mechanisms for human-computer interaction;
in response to determining that a telephonic call from a caller to a callee is a spam call, switching to a mode in which the anti-spambot application initiates a conversation with the caller;
selecting a script from a predetermined set of scripts based on content included in the telephonic call;
generating synthesized speech from the script, based on voice characteristics of the callee; and
conversing with the caller by using the synthesized speech.

9. The system of claim 8, the operations further comprising:
monitoring, by the anti-spambot application, conversations in phone calls and social media, based on permission settings in a profile of the callee; and
sampling vocal characteristics to detect spamming information and topics in real time.

10. The system of claim 8, wherein the synthesized speech is in a language and locale of the callee, the operations further comprising:
evaluating a conversation based on an evaluation criteria including conversation length and reaction of the caller; and
adjusting and improving the predetermined set of scripts for future interaction with callers.

11. The system of claim 8, the operations further comprising:
learning human-computer interaction in previously stored conversations between callers and callees; and
categorizing topics, key words, purposes, roles of caller and callee into different human-computer interaction patterns for conducting automated conversation.

12. The system of claim 8, the operations further comprising:
generating a corpus of anti-spam question-answer scripts for a plurality of topics according to human-computer interaction patterns during spam calls;
translating the corpus of anti-spam question-answer scripts to a plurality of serviced languages; and
saving and updating the corpus of anti-spam question answer scripts.

13. The system of claim 8, the operations further comprising:
defining a framework to support the anti-spambot application; and
providing graphical user interface for managing the anti-spambot application.

14. The system of claim 13, the operations further comprising:
defining a data structure for storing, tracking, and analyzing conversation topics and contexts.

15. A computer program product, the computer program product comprising a computer readable storage medium having computer readable program code embodied therewith, the computer readable program code when executed is configured to perform operations, the operations comprising:
configuring an anti-spambot application that incorporates mechanisms for human-computer interaction;
in response to determining that a telephonic call from a caller to a callee is a spam call, switching to a mode in which the anti-spambot application initiates a conversation with the caller;
selecting a script from a predetermined set of scripts based on content included in the telephonic call;
generating synthesized speech from the script, based on voice characteristics of the callee; and
conversing with the caller by using the synthesized speech.

16. The computer program product of claim 15, the operations further comprising:
monitoring, by the anti-spambot application, conversations in phone calls and social media, based on permission settings in a profile of the callee; and
sampling vocal characteristics to detect spamming information and topics in real time.

17. The computer program product of claim 15, wherein the synthesized speech is in a language and locale of the callee, the operations further comprising:
evaluating a conversation based on an evaluation criteria including conversation length and reaction of the caller; and
adjusting and improving the predetermined set of scripts for future interaction with callers.

18. The computer program product of claim 15, the operations further comprising:
learning human-computer interaction in previously stored conversations between callers and callees; and
categorizing topics, key words, purposes, roles of caller and callee into different human-computer interaction patterns for conducting automated conversation.

19. The computer program product of claim 15, the operations further comprising:
generating a corpus of anti-spam question-answer scripts for a plurality of topics according to human-computer interaction patterns during spam calls;
translating the corpus of anti-spam question-answer scripts to a plurality of serviced languages; and
saving and updating the corpus of anti-spam question answer scripts.

20. The computer program product of claim 15, the operations further comprising:
defining a framework to support the anti-spambot application; and
providing graphical user interface for managing the anti-spambot application.
